(19) United States
(12) Patent Application Publication
(10) Pub. No.: US 2023/0009327 A1
(43) Pub. Date: Jan. 12, 2023

(54) SOUND EMITTING DEVICE

(71) Applicant: Touraj Torabi, Escondido, CA (US)

(72) Inventor: Touraj Torabi, Escondido, CA (US)

(21) Appl. No.: 17/861,222

(22) Filed: Jul. 10, 2022

Related U.S. Application Data
(60) Provisional application No. 63/220,349, filed on Jul. 9, 2021.

(51) Int. Cl. H04R 1/02; F21V 33/00

(52) U.S. Cl. CPC H04R 1/028; F21V 33/0056

(57) ABSTRACT

A sound emitting device is disclosed. The sound emitting device has a housing with a top side, a bottom side opposite the top side, and a housing periphery extending therebetween. A middle area is disposed at a center of the top side wherein the middle area comprises a sealed surface. The sound emitting device has one or more transducers disposed within the housing wherein at least one of the one or more transducers are positioned to emit sound at the sealed surface. While a container of liquid sits on the sealed surface at the top side, the one or more transducers are configured to emit a sound that travels through the sealed surface into the container of liquid.

### CROSS-REFERENCE TO RELATED APPLICATIONS

This application claims benefit of priority with U.S. Provisional Application Ser. No. 63/220,349, filed Jul. 9, 2021; the entire contents of which are hereby incorporated by reference.

### BACKGROUND

### Field of the Invention

This disclosure relates to a sound emitting device and more particularly to a sound emitting device configured to transmit sound into a bottom portion of a liquid container.

### Description of the Related Art

Meditation has been shown to provide many benefits including stress reduction and improvement in concentration. However, meditation can be difficult to perform and may not provide the desired benefits if performed improperly or sub optimally. A key component to meditation, among other breathing exercises, is having a proper mental state. There are a variety of devices which aid in relaxation to assist with proper meditation.

Further, studies have shown that transmitting particular sound frequencies into a container of liquid, such as water, may alter its geometric structure which can provide therapeutic benefits upon consumption. As such, many people find it physically and/or emotionally beneficial to send particular sound waves into liquids prior to consumption. Current solutions to assist with transmitting sound to a liquid container each have their shortcomings. For example, an audio device adapted for altering the structure of water is disclosed by Malcolm in U.S. Pat. No. 9,561,970, issued Feb. 7, 2017. Malcolm discloses a rigid, enclosed cabinet with speakers mounted to the cabinet. The speakers are positioned on opposing walls, facing each other within a cavity and a container is placed within the cabinet. Although the device disclosed in Malcolm is configured to transmit sound waves into a container of liquid, it does so in a bulky and inconvenient manner.

There is a need for a sound emitting device which can aid in proper meditation and further be capable of conveniently transmitting sound to a container of liquid.

### SUMMARY

In one embodiment, a sound emitting device is disclosed. The sound emitting device comprises a housing having a top side, a bottom side opposite the top side, and a housing periphery extending therebetween. A middle area is disposed at a center of the top side wherein the middle area comprises a sealed surface. The sound emitting device has one or more transducers disposed within the housing wherein at least one of the one or more transducers is positioned to emit sound at the sealed surface. While a container of liquid sits on the sealed surface at the top side, the one or more transducers are configured to transmit a sound that travels through the sealed surface into the container of liquid.

In some embodiments, the sound emitting device may further comprise light-emitting components configured to emit light upward through a transparent element into the container of liquid disposed thereon.

Optional controls such as an input interface and screen may be included for controlling settings such as frequency and volume. A power source providing power to the one or more transducers, the light-emitting components, and other electronic including a battery with rechargeable circuitry.

### BRIEF DESCRIPTION OF THE DRAWINGS

These and other features of the invention will become apparent to one having the ordinary level of skill in the art upon a thorough review of the following details and descriptions, particularly when reviewed in conjunction with the drawings, wherein:

FIG. 1 shows a perspective view of a sound emitting device in accordance with a first illustrated embodiment;

FIG. 2 shows a transparent view of the sound emitting device according to the first illustrated embodiment;

FIG. 3 shows a perspective view of a sound emitting device in accordance with a second illustrated embodiment;

FIG. 4 shows a top view of the sound emitting device according to the second illustrated embodiment;

FIG. 5 shows a side view of the sound emitting device according to the second illustrated embodiment; and

FIG. 6 shows a cross-section view of the sound emitting device according to the second illustrated embodiment.

### DETAILED DESCRIPTION OF EMBODIMENTS

For purposes of explanation and not limitation, details and descriptions of certain preferred embodiments are hereinafter provided such that one having ordinary skill in the art may be enabled to make and use the invention. These details and descriptions are representative only of certain preferred embodiments, however, and a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, reference numbers are provided in the drawings for illustrating certain features of embodiments. Where distinct figures of the drawings utilize a shared reference number, it can be appreciated that the feature corresponding to the shared reference number is the same or similar, perhaps observed from a different view, or observed with respect to a different embodiment deploying the same or similar feature.

For purposes herein, the term “sound” means vibrations that travel through air or other medium.

The term “planar” means a flat surface.

The term “periphery” means the outer limits of edge of an object.

The term “transducer” means a device that is configured to transmit sound.

The term “sealed surface” means a surface devoid of apertures.

The term “load cell” means a transducer that converts a force, such as tension, compression, pressure, or torque, into an electrical signal that can be measured and standardized.

The term “orthogonal” between a transducer and a side of the housing means comprising a perpendicular relationship between the side and a direction of sound emitted from the transducer wherein the perpendicular relationship has an angle between eighty-five and ninety-five degrees.

Unless explicitly defined herein, terms are to be construed in accordance with the plain and ordinary meaning as would be appreciated by one having skill in the art.

### GENERAL DESCRIPTION OF EMBODIMENTS

In one general embodiment, a sound emitting device is disclosed. The sound emitting device comprises a housing having a top side, a bottom side opposite the top side, and a housing periphery extending therebetween. A middle area is disposed at a center of the top side, wherein the middle area comprises a sealed surface. One or more transducers are disposed within the housing, wherein at least one of the one or more transducers is positioned to emit sound at the sealed surface. The top side is configured to hold a liquid container.

In some embodiments, each of the one or more transducers may be positioned to emit sound at the sealed surface.

In some embodiments, at least one of the or more transducers may be orthogonal to the top side.

In some embodiments, each of the one or more transducers may be orthogonal to the top side.

In some embodiments, the housing periphery may comprise a curvature extending outward from the top side and the bottom side.

In some embodiments, the sealed surface may be a planar surface. In some embodiments, the middle area may be a planar surface.

In some embodiments, the sealed surface may be devoid of apertures in order to prevent liquid from damaging the one or more transducers electronics contained in the housing. In some embodiments, the middle area may be devoid of apertures.

In some embodiments, at least a portion of the middle area may comprise a transparent element.

In some embodiments, the housing may further comprise one or more light-emitting components configured to emit light through the transparent element.

In some embodiments, the housing periphery may be devoid of apertures in order to direct all sound being produced by the one or more transducers towards to the top side.

In some embodiments, the housing periphery may comprise one or more openings in order to allow a user to simultaneously hear the sound being emitted towards the container of liquid.

In some embodiments, the middle area may comprise a recessed area where the recessed area extends into an interior of the housing.

In some embodiments, the one or more transducers may each be disposed between the bottom side and the recessed area.

In some embodiments, the sound emitting device may further comprising a transparent element disposed over the recessed area wherein the transparent element and the top side form a planar surface.

In some embodiments, the sound emitting device may further comprise one or more light-emitting components disposed between the transparent element and the one or more transducers.

In some embodiments, the sound emitting device may further comprise a load cell for sensing presence and weight of the container of liquid.

In some embodiments, the top side may further comprise a raised perimeter disposed at an edge thereof for being securing the container of liquid. The raised perimeter may be rigid for holding a container of a particular size, or may be flexible in order to hold various sized containers.

In some embodiments, the housing may further comprise one or more input controls wherein at least one of the one or more input controls comprises a frequency adjustor.

In some embodiments, the sealed surface may further comprise a sealed surface periphery wherein the sealed surface periphery and the housing periphery share a common shape. In some embodiments, the common shape is a circle.

In some embodiments, the sealed surface may be concentrically aligned with the center of the top side.

In a second general embodiment, a sound emitting device is disclosed. The sound emitting device comprises a housing having a top side, a bottom side opposite the top side, and a housing periphery extending therebetween. One or more transducers are disposed within the housing, wherein at least one of the one or more transducers are positioned to emit sound toward the top side. The housing periphery is configured to prevent sound from passing therethrough in order to direct all sound produced by the one or more transducers toward the top side.

In some embodiments, the housing periphery is devoid of apertures. In other embodiments, the housing periphery may comprise one or more apertures and further comprises a sealing barrier disposed over the one or more apertures in order to prevent sound from traveling through the one or more apertures.

In some embodiments, the top side may further comprise a middle area disposed at a center of the top side, wherein the middle area comprises a sealed surface.

In some embodiments, each of the one or more transducers may be positioned to emit sound at the sealed surface.

In some embodiments, at least one of the or more transducers may be orthogonal to the top side.

In some embodiments, each of the one or more transducers may be orthogonal to the top side.

In some embodiments, the housing periphery may comprise a curvature extending outward from the top side and the bottom side.

In some embodiments, the sealed surface may be a planar surface. In some embodiments, the middle area may be a planar surface.

In some embodiments, the sealed surface may be devoid of apertures in order to prevent liquid from damaging the one or more transducers electronics contained in the housing. In some embodiments, the middle area may be devoid of apertures.

In some embodiments, at least a portion of the middle area may comprise a transparent element.

In some embodiments, the housing may further comprise one or more light-emitting components configured to emit light through the transparent element.

Liquid.

In some embodiments, the middle area may comprise a recessed area where the recessed area extends into an interior of the housing.

In some embodiments, the one or more transducers may each be disposed between the bottom side and the recessed area.

In some embodiments, the sound emitting device may further comprising a transparent element disposed over the recessed area wherein the transparent element and the top side form a planar surface.

In some embodiments, the sound emitting device may further comprise one or more light-emitting components disposed between the transparent element and the one or more transducers.

In some embodiments, the sound emitting device may further comprise a load cell for sensing presence and weight of the container of liquid.

In some embodiments, the top side may further comprise a raised perimeter disposed at an edge thereof for being securing the container of liquid. The raised perimeter may be rigid for holding a container of a particular size, or may be flexible in order to hold various sized containers.

In some embodiments, the housing may further comprise one or more input controls wherein at least one of the one or more input controls comprises a frequency adjustor.

In some embodiments, the sealed surface may further comprise a sealed surface periphery wherein the sealed surface periphery and the housing periphery share a common shape. In some embodiments, the common shape is a circle.

In some embodiments, the sealed surface may be concentrically aligned with the center of the top side.

In a third general embodiment, a sound emitting device is disclosed. The sound emitting device comprises a housing having a top side, a bottom side opposite the top side, and a housing periphery extending therebetween. One or more transducers are contained within the housing. One or more transducer openings are disposed on the top side wherein each of the one or more transducer openings is vertically above and concentrically aligned with the one or more transducers wherein the one or more transducers are between the one or more transducer openings and the bottom side. Each of the one or more transducers are configured to emit sound through an associated transducer opening.

In some embodiments, the sound emitting device may comprise a single transducer and a single transducer opening positioned center of the top side. In other embodiments, the sound emitting device may comprise a plurality of transducers and a plurality of transducer openings.

In some embodiments, the sound emitting device may comprise an equal number of transducers and transducer openings.

In one aspect, a method of providing sound to a liquid container is disclosed. The method comprises (i) receiving the liquid container with a particular weight on the sound emitting device having a top side, one or more transducers configured to emit sound, and a load cell; (ii) sensing the liquid container with the load cell and converting the particular weight into an electrical signal; (iii) turning on the one or more transducers based on the electrical signal; (iv) emitting sound from the one or more transducers towards the top side and into the liquid container.

In some aspects, the sound may comprise a plurality of frequencies. In other embodiments, the sound may comprise a single frequency.

In some aspects the method may further comprise adjusting the sound to a particular frequency based on the particular weight of the liquid container.

In some aspects, the method may further comprise adjusting the sound to a particular frequency based on a preset schedule based on time of day.

In some aspects, the sound emitting device may further comprise one or more light-emitting components which are configured to turn on with a particular light wavelength and a particular light intensity based on the particular weight of the liquid container.

### Manufacturing

The transducer can be obtained commercially, for example and without limitation, B07XDPXH7K from RLECS. Alternatively, the transducer can be customized in accordance with the level and knowledge of one having skill in the art.

Generally, the housing is made of ceramic or plastic. Otherwise, the housing can be fabricated in accordance with the level and knowledge of one having skill in the art.

The screen can be obtained commercially, for example and without limitation, SSD1306 from HiLetgo. Alternatively, the screen can be customized in accordance with the level and knowledge of one having skill in the art.

The microcontroller can be obtained commercially, for example and without limitation, Mini Nano V3.0 ATmega328P from Arduino. Alternatively, the microcontroller can be customized with discrete parts in accordance with the level and knowledge of one having skill in the art.

The load cell can be obtained commercially, for example and without limitation, FZ0728 and FZ1439 from Geekstory. Alternatively, the load cell can be customized in accordance with the level and knowledge of one having skill in the art.

The light-emitting component can be obtained commercially, for example and without limitation, SMD5050 from XNBada Lights. Alternatively, the light-emitting component can be customized in accordance with the level and knowledge of one having skill in the art.

Each of the components of the sound emitting device and related system described herein may be manufactured and/or assembled in accordance with the conventional knowledge and level of a person having skill in the art.

### First Illustrated Embodiment

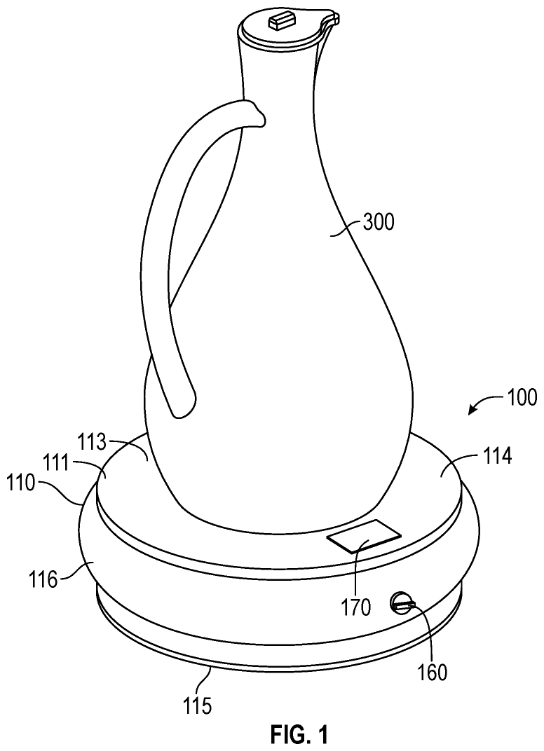

Now turning to the drawings, FIG. 1 shows a perspective view of a sound emitting device (100) in accordance with a first illustrated embodiment. The sound emitting device comprises a housing (110) having a top planar side (111) and a bottom planar side (115) opposite the top planar side. Disposed between the top and bottom planar sides is a housing periphery (116) extending therebetween. The top planar side comprises a flat surface configured to hold a liquid container (300) disposed thereon. The top planar side, as shown, has a sealed surface (114) where no apertures or perforations are present to prevent liquid from entering the housing and damaging components therein. In other embodiments, the top planar side may comprise apertures near an edge of the top planar side while having a middle area (113) which is a sealed surface. Contained within the housing is one or more transducers (not shown) which are positioned upwards facing the top planar side, such that the one or more transducers is configured to emit sound in an upward direction towards the liquid container. Sound emitted in such a manner translates through the top planar side, through the liquid container, and into liquid contained with the liquid container.

The sound emitting device (100) further includes an input interface (160) disposed on the housing periphery (116) and a screen (170) disposed on the top planar side (111), each of which is configured for user input and control. The screen may display information such as volume, frequency, weight, duration, and other relevant data that can be appreciated by one having skill in the art. A user may adjust measurements such as volume and frequency with the input interface to a desired level, or schedule the like for later use. Examples of the input interface may include, but is not limited to, a button, knob, dial, or touch sensitive controls. The user may set the frequency and/or volume being emitted from the one or more transducers using a frequency adjustor depending on factors such as type of liquid, amount of liquid, and time of day. For example, the user may prefer to transmit a frequency of 639 Hz early in the day and 285 Hz later in the day.

In some embodiments, the sound emitting device (100) may further comprise a wireless receiver configured to receive a wireless signal from a smartphone, computer, or other electronic device. In such embodiments, a software application can be used to control features already described herein, and may obviate the need for the screen (170) and input interface (160). Wireless technologies such as WIFI, Bluetooth, HFC, and the like may each or individually be utilized for wireless communication with the electronic device.

The housing periphery (116) as shown is sealed throughout, thereby increasing efficient of sound being transmitted by the one or more transducers through the top planar side (111) and into the liquid container (300). In other embodiments, the housing periphery may comprise one or more openings or perforations to allow sound to transmit laterally out of the housing periphery in addition to the sound transmitting upwards towards the top planar side. One advantage of such a feature may include an immersive experience for the user and to hear more clearly the sound being transmitted into the liquid container. In yet other embodiments, the bottom planar portion (115) may include openings or perforations, instead of or in addition to the housing periphery, for achieving a more immersive experience.

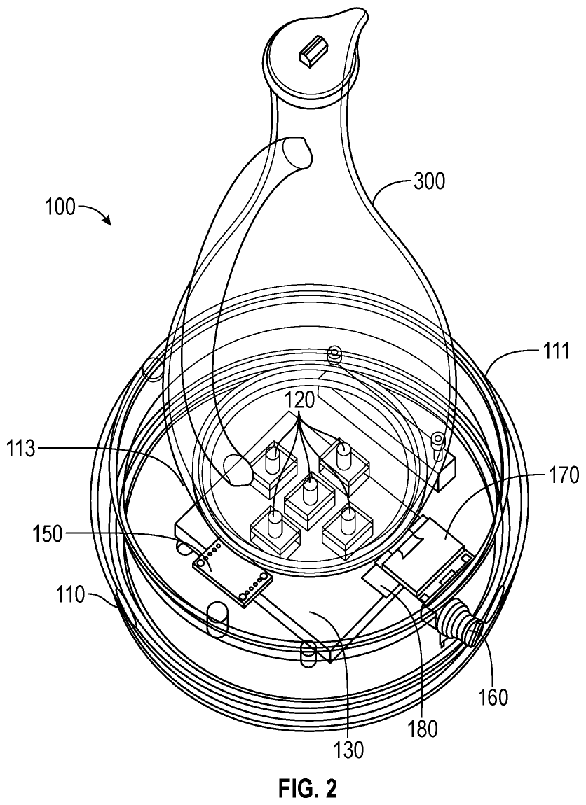

FIG. 2 shows a transparent view of the sound emitting device (100) according to the first illustrated embodiment. The sound emitting device comprises a housing (110) having a top planar side (111) configured to hold one or more liquid containers (300). An input interface (160) and a screen (170) are each integrated with the housing and each are electrically coupled to electronics contained within the housing. The electronics includes one or more transducers (120), a load cell, (150), a power source (130), a microcontroller (180) and other components appreciated by one having skill in the art.

The one or more transducers (120) are each pointed upwards towards the top planar side (111) and the liquid container (300). The sound emitting device (100), as shown, comprises five transducers disposed in a middle area (113) of the housing (110). In other embodiments, the sound emitting device may comprise only a single transducer capable of transmitting an appropriate range of frequencies at a desirable sound pressure level (SPL) sufficient to translate into the liquid container. Generally, the transducers are disposed near the middle area but can alternatively be disposed throughout to cover a wider area, which may be better suited for liquid containers having larger bases.

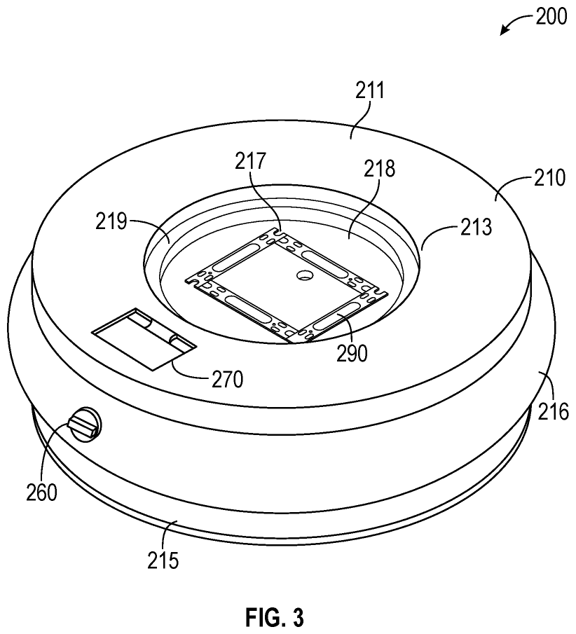

The load cell (150) is configured to measure weight being applied to the top planar side (111) of the housing (110). Such information can be sent to the microcontroller (180) electrically coupled therewith. The microcontroller can use the information provided by the load cell to sense when the liquid container (300) is present for purposes of turning on the sound emitting device (100). The microcontroller may further utilize information received by the load cell to transmit a SPL from the transducers (120) corresponding to the weight measured, such as a higher SPL for a larger weight container and a lower SPL for a lesser weight container. Additionally, if the sound emitting device comprises one or more light-emitting components (290, FIG. 3), the microcontroller can change the intensity and/or color emitted from the light-emitting components depending on the weight of the liquid container or frequency of the sound.

The power source (130) as shown is a battery, such as a lithium battery popular in many consumer electronics. For reuse, the source emitting device may further comprise charging circuitry configured to recharge the battery for repeated use. In some embodiments, the sound emitting device (100) does not comprise a battery and instead is configured to receive DC or AC to provide power to the electronics contained within an interior of the housing (110).

In some embodiments, the electronics may further include an amplifier configured to increase a voltage signal to an adequate level as can be appreciated by one having skill in the art after factoring transducer specifications and desired power output level of the one or more transducers. In other embodiments, the voltage level coming from the power source may be sufficient for the transducers without amplification from an amplifier or equivalent circuitry.

### Second Illustrated Embodiment

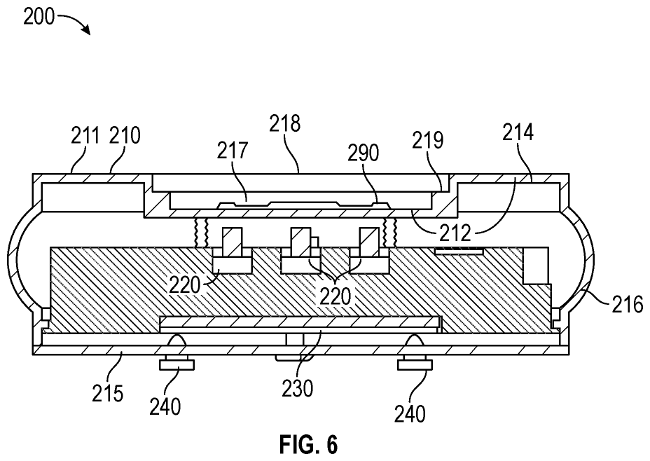

FIG. 3 shows a perspective view of a sound emitting device (200) in accordance with a second illustrated embodiment. The sound emitting device includes a housing (210) having a top planar side (211) and a bottom planar side (215) opposite the top planar side. At a middle area (213), the top planar side includes a recessed area (217) disposed therein. A transparent element (218) is engaged with the top planar side at a rim (219) such that a combination of the top planar side and the transparent element creates a flat surface configured to hold a liquid container thereon. Disposed within the recessed area is one or more light-emitting components (290). The light-emitting components are configured to emit light through the transparent element into the liquid container disposed thereon. One or more transducers (220, FIG. 6) are disposed below the recessed area and are each configured to transmit sound through the recessed area, the transparent element, and/or the top planar side into the liquid container.

In some embodiments, the top planar side (211) may further comprise a raised perimeter extended upward which is configured to better engage a liquid container having a particular diameter.

The housing (210) further comprises a housing periphery (216) extending from the top planar side (211) to the bottom planar side (215). The housing periphery comprises a curvature such that the housing periphery extends outward laterally more than the top or bottom planar sides. The curvature provides multiple advantages such as an increase rigidity to reduce vibration of the housing while the one or more transducers (not shown) are transmitting. The housing periphery may be circular as shown, or alternatively can be rectangular, triangular, or any other shape that can be appreciated by one having skill in the art.

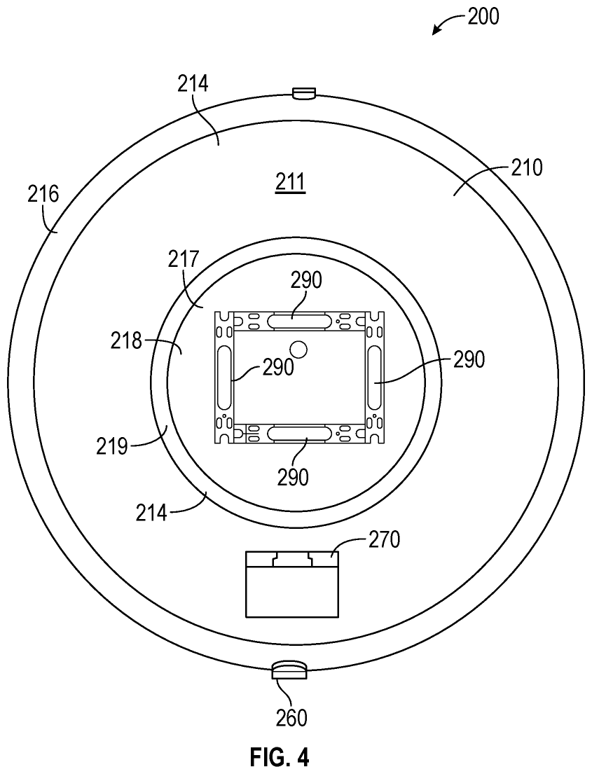

FIG. 4 shows a top view of the sound emitting device (200) according to the second illustrated embodiment. The sound emitting device comprises a housing (210) having a top planar side (211), wherein at least a portion of the top planar side includes a sealed surface. At a center of the top planar side includes a transparent element (218) configured to cover a recessed area (217) disposed underneath. The recessed area comprises one or more light-emitting components (290), wherein the one or more light-emitting components are electrically coupled to electronics (not shown) contained within the housing. The transparent element engages with a rim (219) of the recessed area such that a flat surface exists between the top planar side and transparent element. A housing periphery (216) extends from the top planar side down to a bottom planar side (not shown). The housing periphery comprises a curvature which extends outward from the top planar side and provides the housing resistance to vibration.

In a preferable embodiment, the top planar side (211) comprises a sealed surface such that no openings, apertures, or perforations are present to allow liquid or dirt into the housing (210) which can damage electronics contained therein. In other embodiments, the top planar side may comprise one or more apertures configured to more easily allow sound transmitted from transducers (220, FIG. 6) toward a liquid container located above.

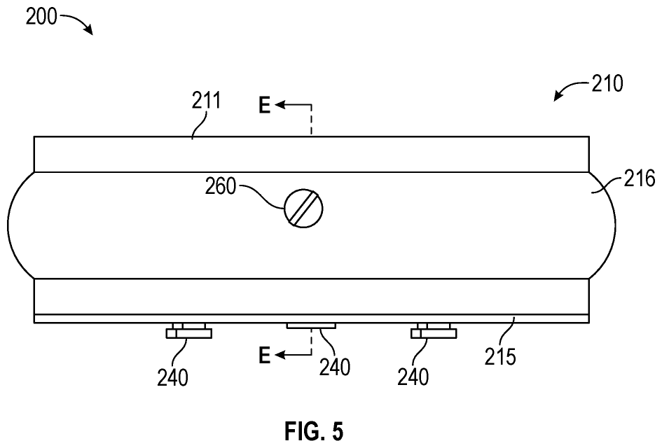

FIG. 5 shows a side view of the sound emitting device (200) according to the second illustrated embodiment. The sound emitting device comprises a housing (210) with electronics (not shown) contained therein for transmitting sound and/or light into a liquid container disposed on a top planar side (211) of the housing. A housing periphery (216) extends from the top planar side to a bottom planar side (215). Coupled to the bottom planar side are a plurality of rubber feet (240) configured to prevent scratching of the sound emitting device in addition to reducing vibrations generated by one or more transducers (220, FIG. 6). A user interface (260) is integrated within the housing periphery. The user interface allows a user to adjust frequency and/or volume, in addition to other settings as so desired.

FIG. 6 shows a cross-section view of the sound emitting device (200) according to the second illustrated embodiment. The sound emitting device comprises a housing (210) having a top planar side (211), a bottom planar side (215), and a housing periphery (216) extending therebetween. At the top planar side is a recessed area (217) having one or more light-emitting components (290). Contained within the housing is a myriad of electronics including one or more transducers (220) disposed beneath the recessed area and positioned upwards such that sound transmitted from the one or more transducers travel upwards through the recessed area and/or top planar side. A transparent element is coupled to the housing at a rim (219). The transparent element allows light and/or sound being emitted underneath to translate therethrough and into a liquid container disposed thereof. The transparent element may comprise glass, plastic, or other transparent materials known in the art. The sound emitting device further comprises a power source (230) for providing power to the one or more transducers and other electronics.

The top planar portion (211), which includes the recessed area (217), further comprises a top planar thickness (212). The top planar thickness may be uniform or vary through the top planar side. Generally, the top planar thickness comprises a thickness small enough for allowing sound to translate through with minimal degradation. Sufficient thickness will be appreciated by one having skill in the art when factoring in housing material, transducer output power, output frequency, and desired volume.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### FEATURE LIST

frequency wave emitting device (100; 200)
housing (110; 210)
top planar side (111; 211)
top planar thickness (112; 212)
middle area (113; 213)
sealed surface (114; 214)
bottom planar side (115; 215)
housing periphery (116; 216)
transducer (120; 220)
power source (130; 230)
feet (140; 240)
load cell (150; 250)
input interface (160; 260)
screen (170; 270)
microcontroller (180; 280)
recessed area (217)
transparent element (218)
rim (219)
light-emitting components (290)
liquid container (300)

What is claimed:

1. A sound emitting device, comprising:
a housing having a top side, a bottom side opposite the top side, and a housing periphery extending therebetween;
a middle area disposed at a center of the top side, the middle area comprising a sealed surface; and
one or more transducers disposed within the housing, wherein at least one of the one or more transducers are positioned to emit sound at the sealed surface.

2. The sound emitting device of claim 1, wherein each of the one or more transducers are positioned to emit sound at the sealed surface.

3. The sound emitting device of claim 1, wherein at least one of the or more transducers are orthogonal to the top side.

4. The sound emitting device of claim 1, wherein each of the one or more transducers are orthogonal to the top side.

5. The sound emitting device of claim 1, wherein the housing periphery comprises a curvature extending outward from the top side and the bottom side.

6. The sound emitting device of claim 1, wherein the sealed surface is a planar surface.

7. The sound emitting device of claim 1, wherein the sealed surface is devoid of apertures.

8. The sound emitting device of claim 1, wherein at least a portion of the middle area comprises a transparent element.

9. The sound emitting device of claim 10, further comprising one or more light-emitting components configured to emit light through the transparent element.

10. The sound emitting device of claim 1, wherein the housing periphery is devoid of apertures.

11. The sound emitting device of claim 1, wherein the housing periphery comprises one or more openings.

12. The sound emitting device of claim 1, the middle area further comprising a recessed area, the recessed area extending into an interior of the housing.

13. The sound emitting device of claim 12, wherein the one or more transducers are each disposed between the bottom side and the recessed area.

14. The sound emitting device of claim 12, further comprising a transparent element disposed over the recessed area wherein the transparent element and the top side form a planar surface.

15. The sound emitting device of claim 14, further comprising one or more light-emitting components disposed between the transparent element and the one or more transducers.

16. The sound emitting device of claim 1, further comprising a load cell.

17. The sound emitting device of claim 1, the top side further comprising a raised perimeter disposed at an edge thereof.

18. The sound emitting device of claim 1, the housing further comprising one or more input controls wherein at least one of the one or more input controls comprises a frequency adjustor.

19. The sound emitting device of claim 1, the sealed surface further comprising a sealed surface periphery wherein the sealed surface periphery and the housing periphery share a common shape.

20. The sound emitting device of claim 1, wherein the sealed surface is concentrically aligned with the center of the top side.
